(19) United States
(12) Patent Application Publication
(10) Pub. No.: US 2005/0010898 A1
(43) Pub. Date: Jan. 13, 2005

(54) Program generation apparatus, program generation method, and program for program generation

(76) Inventors: Hajime Ogawa, Suita-shi (JP); Shuichi Takayama, Takarazuka-shi (JP); Taketo Heishi, Osaka-shi (JP); Chen Zhao, Beijing (CN)

Correspondence Address: WENDEROTH, LIND & PONACK, L.L.P., 2033 K STREET N. W., SUITE 800, WASHINGTON, DC, 20006-1021, US

(21) Appl. No.: 10/880,529

(22) Filed: Jul. 1, 2004

(30) Foreign Application Priority Data
Jul. 9, 2003 (CN) 03147238.9

(51) Int. Cl. G06F 9/44

(52) U.S. Cl. 717/106; 717/136; 717/124

(57) ABSTRACT

A program generation apparatus according to the present invention includes a translation unit and a generation unit. The translation unit accepts a single HLSL (high level scripting language) script that defines a variety of program structures for programs to be generated, and translates the HLSL script into a plurality of MLSL (middle level scripting language) scripts, each of which describes one of the plurality of program structures defined by the HLSL script, which are different from each other. The generation unit generates programs that respectively correspond to the plurality of MLSL scripts.

### BACKGROUND OF THE INVENTION

(1) Field of the Invention

The present invention relates to a program generation apparatus for generating programs automatically, and particularly to a program generation apparatus for generating source programs, as test programs, for verifying operation of a language processor such as a compiler.

(2) Description of the Related Art

A conventional program generation apparatus is disclosed in Japanese Laid-Open Patent Application No. 05-342054 Publication, for example. This is a program generation apparatus for generating test programs for verifying operation of a language processor such as a compiler. To be more specific, this program generation apparatus previously holds a plurality of templates of structure data indicating control structures in programs, and generates test programs according to scripts that respectively specify one or more of the templates.

FIG. 1 is a diagram showing an example of the structure data in the above conventional program generation apparatus. As shown in FIG. 1, the structure data numbered 1 indicates a control structure for iterations (one loop structure). The structure data numbered 20 indicates control structures for one loop structure containing dual loop structures as nests in parallel.

FIG. 2 shows an example of a script and a test program in the above-mentioned conventional program generation apparatus. In FIG. 2, a script 2a defines two structure data 1, namely, two loop structures. A test program 2b is automatically generated according to this script 2a. This test program 2b has a program structure having dual loop structures consisting of “for” statements in parallel.

FIG. 3 shows another example of a script and a test program. In FIG. 3, a script 3a defines one structure data 1 and one structure data 20. A test program 3b is automatically generated according to this script 3a. The test program 3b has dual loop structures consisting of “for” statements in parallel, in which the second loop further contains dual loop structures as nests in parallel.

As described above, the automatic program generation apparatus as disclosed in the conventional art generates test programs having control structures that correspond to structure data defined by scripts. Since all that a programmer has to do is write simple scripts that define structure data, man-hours for writing the details of the test programs are reduced.

However, this conventional automatic program generation apparatus has a problem of requiring an enormous number of man-hours for script writing in order to generate a lot of test programs having a variety of program structures. That is why only one test program is generated from a single script, and in order to generate a plurality of test programs having a variety of program structures, a programmer has to create the same number of scripts corresponding to the test programs. In addition, a lot of structure data must be previously prepared.

For example, in the case where, in order to verify operation of a compiler, a random test is carried out using a plurality of test programs having a variety of program structures, or a test program consisting of complex combinations of specific control structures such as loop structures and if structures, an enormous number of man-hours is needed to tailor the scripts for specific test programs. Therefore, the above-mentioned conventional art is not practical for generation of a variety of test programs.

### SUMMARY OF THE INVENTION

An object of the present invention is to provide a program generation apparatus that realizes generation of a plurality of test programs having a variety of program structures with a smaller number of man-hours.

Another object of the present invention is to provide a program generation apparatus that allows programmers to easily check the execution results of test programs.

In order to achieve the above objects, the program generation apparatus according to the present invention includes: an accepting unit operable to accept a first script that defines a plurality of program structures for programs to be generated; and a script generating unit operable to generate a plurality of second scripts, each of which describes one of the plurality of program structures defined by the first script, said one of the plurality of program structures being different from each other.

According to this configuration, the program generation apparatus generates a plurality of second scripts from a single first script. Therefore, all that a programmer has to do is create only one first script, and thus a plurality of programs having a variety of program structures can be realized with a small number of man-hours.

Here, the program generation apparatus may be configured so that the first script defines the plurality of program structures by indicating a plurality of arrangements of control structures in the programs to be generated, each of the second scripts describes a program structure that indicates a unique arrangement of one or more of the control structures, and the script generating unit generates the plurality of second scripts by arranging the control structures based on the plurality of arrangements indicated in the first scrip.

According to this configuration, the first script indicates a plurality of various arrangements of control structures. Therefore, a programmer can create the first script easily.

Here, the control structure may be at least one of a loop structure, an if-then branch structure and an if-then-else branch structure.

Also, the first script may include an indication of paralleling and nesting of the control structures.

In addition, the program generation apparatus may be configured so that the first script includes an indication of the number of programs to be generated, and the script generating unit generates the plurality of second scripts, the number of said generated second scripts being indicated in the first script, and said second scripts describing the program structures selected, on a random basis, from among the plurality of program structures defined by the first script.

According to this configuration, the program generation apparatus generates the specified number of programs. Therefore, a programmer can cause the program generation apparatus to generate his/her desired number of programs.

Here, the program generation apparatus may further include a program generating unit operable to generate programs that respectively correspond to the plurality of second scripts generated by the script generating unit.

According to this configuration, the accepting unit, the script generating unit and the program generating unit work with each other in a chain. Therefore, upon accepting a single first script, a plurality of second scripts and a plurality of test programs can be generated one after another.

Here, the program generation apparatus may be configured so that the first script further includes a parameter indicating that a specific program statement should be set at a plurality of points in each of the programs, the script generating unit puts a mark that represents the parameter at a plurality of points in each of the second scripts, and the program generating unit sets the specific program statement at the points in each of the programs that correspond to the points of marks put in each of the second scripts.

Also, the program generation apparatus may be configured so that the specific program statement is one of the following: an output statement indicating that one of a character string and a variable should be outputted; and a pair of assignment statements that have data dependency.

According to this configuration, the program generation apparatus inserts a specific program statement into a program to be generated. Therefore, by executing the specific program statement (data dependency or output statement) during execution of the compiled program, a programmer can verify the operation of the compiler more easily and securely.

In addition, the method, program and script for program generation of the present invention have the same structures, functions and effects as those of the program generation apparatus described above.

As further information about technical background to this application, the disclosure of Chinese Patent Application No. 03147238.9 filed on Jul. 9, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing structure data in conventional art;

FIG. 2 is a diagram showing an example of a script and a test program in the conventional art;

FIG. 3 is a diagram showing another example of a script and a test program in the conventional art;

FIG. 4 is an external view of a test program generation apparatus in an embodiment of the present invention;

FIG. 5 is a functional block diagram showing a configuration of the test program generation apparatus;

FIG. 6 is a diagram showing an example of scripts written in a high-level scripting language (HLSL) and a middle-level scripting language (MLSL), and test programs;

FIG. 7 is an explanatory diagram showing syntaxes of an HLSL script;

FIG. 8 is a more detailed functional block diagram of a translation unit;

FIG. 9 is a flowchart showing parameter reading processing;

FIG. 10 is a flowchart showing control structure generation processing;

FIG. 11 is a flowchart showing processing for generating a plurality of MLSL scripts having if control structures;

FIG. 12 is a diagram showing a complete tree T;

FIG. 13 is a diagram showing MLSL scripts that correspond to the complete tree T and subtrees S1 to S8;

FIG. 14 is a flowchart showing processing for generating an MLSL script having a plurality of if-then-else control structures;

FIG. 15 is a diagram showing an example of an HLSL script and the corresponding complete tree;

FIG. 16 is a diagram showing an example of a subtree and the corresponding MLSL script;

FIG. 17 is a diagram showing another example of a subtree and the corresponding MLSL script;

FIG. 18 is a diagram showing still another example of a subtree and the corresponding MLSL script;

FIG. 19 is a flowchart showing processing for generating a plurality of MLSL scripts having loop control structures;

FIG. 20 is a flowchart showing additional information generation processing;

FIG. 21 is a diagram showing an example of additional information setting and the corresponding test program;

FIG. 22 is a diagram showing another example of additional information setting and the corresponding test program;

FIG. 23 is a detailed block diagram of a generation unit 3;

FIG. 24 is a flowchart showing data dependency setting processing; and

FIG. 25 is a flowchart showing comparison point setting processing.

### DESCRIPTION OF THE PREFERRED EMBODIMENT

A program generation apparatus in the embodiment of the present invention will be explained below.

(External View)

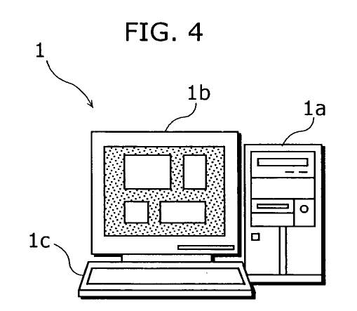

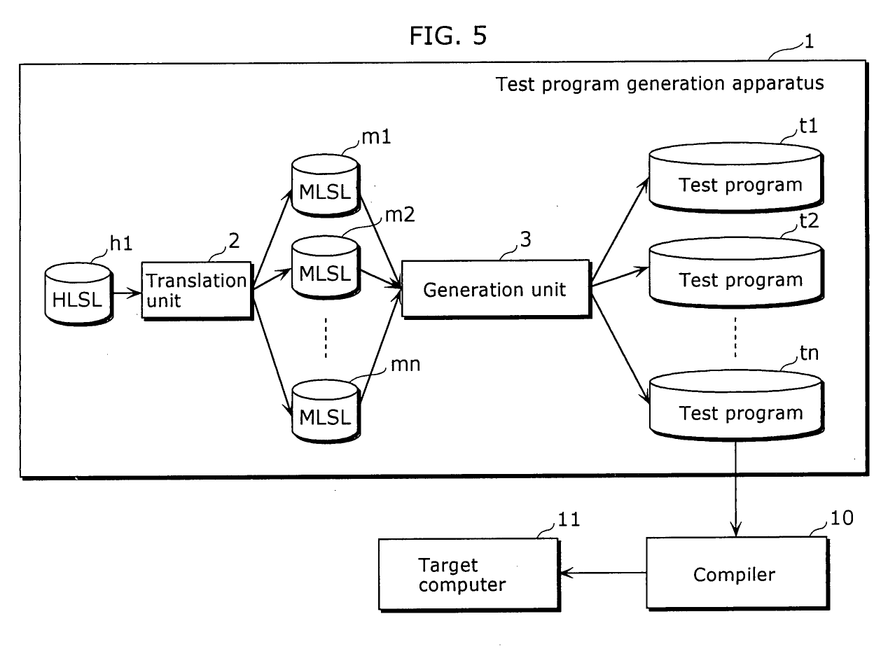

FIG. 4 is an external view of a test program generation apparatus 1 in the present embodiment. As shown in FIG. 4, the test program generation apparatus 1 includes a control device 1a, a display device 1b and an input device 1c. This hardware configuration is same as that of a typical personal computer or a work station. The program generation apparatus of the present invention is realized by executing specific software that describes the functions of the program generation apparatus (or the program generation method of the present invention) on the above-mentioned hardware.

(Configuration Overview)

FIG. 5 is a functional block diagram showing the configuration of the test program generation apparatus 1. In FIG. 5, the test program generation apparatus 1 includes a translation unit 2 and a generation unit 3.

The translation unit 2 generates a plurality of files written in a middle level scripting language from a single file written in a high level scripting language.

The generation unit 3 generates one test program from each of the plurality of files written in a middle level scripting language.

According to this configuration, all that a programmer has to do is create a single file written in a high level scripting language, and thus the test program generation apparatus 1 can generate a plurality of test programs having a variety of program structures from that single file.

A high level scripting language and a middle level scripting language will be hereinafter referred to as HLSL and MLSL respectively. Similarly, a file written in HLSL and a file written in MLSL will be referred to as an HLSL script and an MLSL script respectively.

In addition, FIG. 5 shows an HLSL script h1, “n” number of MLSL scripts m1 to mn, and “n” number of test programs t1-tn.

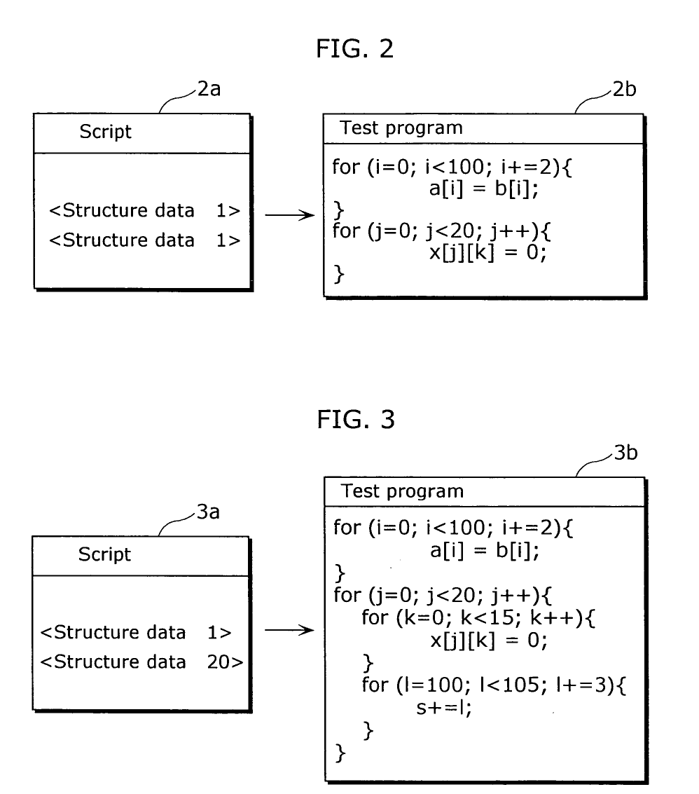

Here, an HLSL script is a file that defines a variety of arrangements (or combinations) of control structures in a program, and represents, in a comprehensive manner, a variety of program structures defined by the variety of arrangements (or combinations) of control structures. In other words, an HLSL script defines control structures to be arranged and indicates a variety of arrangements of the defined control structures at a plurality of locations in a program. On the other hand, an MLSL script is a file that represents one program structure, like a script 2a or 3a as shown in FIG. 2 or FIG. 3, and indicates a unique arrangement of control structures at a plurality of locations in a program.

The test program generation apparatus 1 can generate a plurality of MLSL scripts and a plurality of test programs from a single HLSL Script.

(Example of Program Generation)

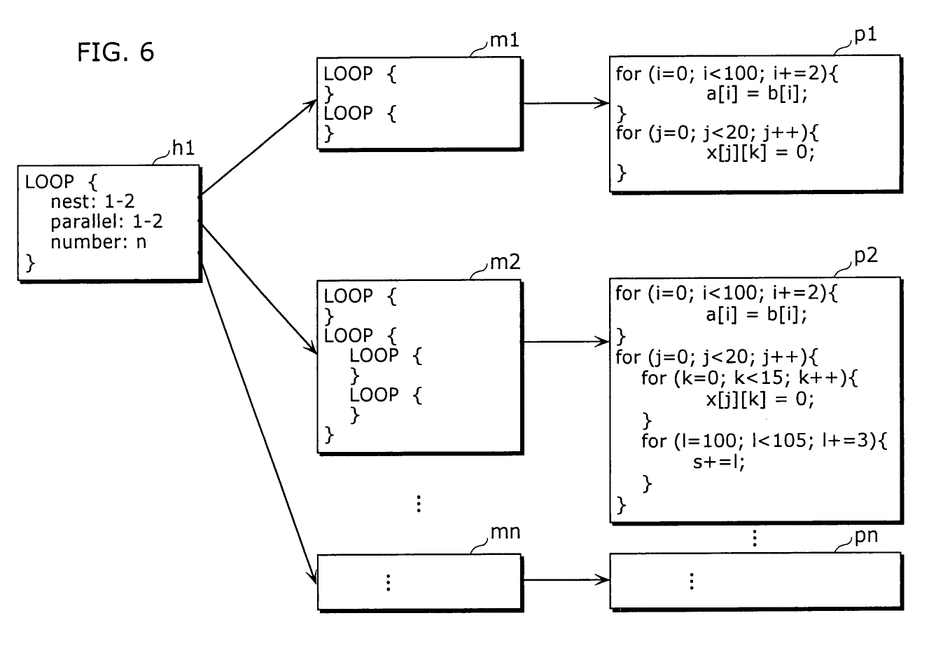

FIG. 6 is a diagram showing an example of an HLSL script, MLSL scripts and test programs. In FIG. 6, “n” MLSL scripts and “n” test programs are generated from a single HLSL script.

The HLSL script h1 in this diagram indicates an example where parameters and the like define a control structure type as LOOP and how to arrange the loop structures. The HLSL script h1 defines, in this case, that the nesting depth of the loop structures is 1 to 2 and the number of parallel loop structures is 1 to 2.

Each of the MLSL scripts m1 to mn is a file that describes one arrangement among a variety of arrangements defined by the HLSL script h1. For example, it corresponds to the script 2a or 3a as mentioned in the conventional art using FIG. 2 or FIG. 3.

The test programs t1 to tn are test programs that correspond to the MLSL scripts m1 to mn one to one. In FIG. 6, they are generated as source programs written in C language.

As described above, the test program generation apparatus 1 generates “n” MLSL scripts from a single HLSL script, and further generates “n” test programs from the “n” MLSL scripts.

Each of the generated test programs is converted into a machine language program through compilation by a compiler 10 as shown in FIG. 5. This machine language program is executed by a target computer 11 (or the simulator for the computer) as shown in FIG. 5, for verification of the operation of the compiler. Note that the compiler 10 is realized by executing compiler software on the personal computer as shown in FIG. 4, for example. The target computer 11 (or the simulator for the computer 11) is a home electrical product or the like that is controlled by a general-purpose computer or an embedded microcomputer. For example, it is a DVD recorder/player, a set top box (STB), a digital still camera, a digital video camera or the like. It is the simulator for the target computer 11 itself in the case where the hardware for it has not yet been developed.

(HLSL Syntax)

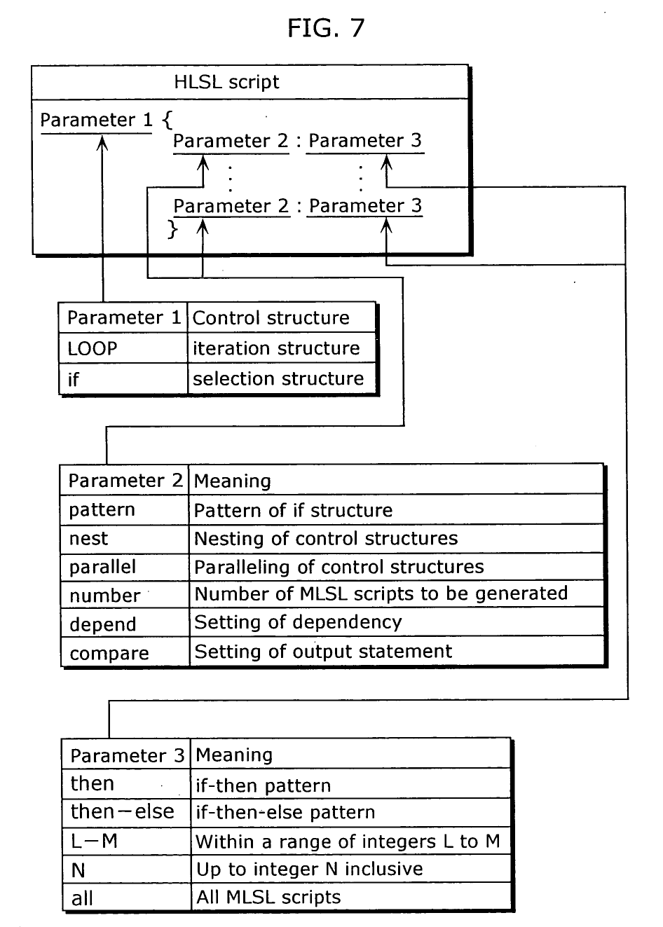

FIG. 7 is an explanatory diagram showing syntaxes of an HLSL script. As shown in FIG. 7, one or more syntaxes like “parameter 1 {parameter 2: parameter 3 . . . }” can be written on an HSLS script.

The parameter 1 specifies a control structure which should be set in the program structure. Here, a control structure generally means an element for controlling an execution flow of a program. There are various control structures such as a sequential structure, an iteration structure and a selection structure (or a branch structure). An execution flow of a program (that is, a program structure) is determined by an arrangement (a combination) of these control structures. As shown in FIG. 7, a control structure which is specified by a parameter 1 indicates an iteration structure if it is “LOOP”, and a selection structure if it is “if”. The “if” selection structure further includes structures of an “if-then” pattern and an “if-then-else” pattern. In the case where the parameter 1 is “if”, an “if-then” pattern and an “if-then-else” pattern can be specified by the parameters 2 and 3.

To be more specific, the parameter 2 includes “pattern”, “nest”, “parallel”, “number” “depend”, “compare” and the like.

“pattern” specifies an “if-then” structure or an “if-then-else” structure, in the case where the control structure specified by the parameter 1 is the “if” structure. If the parameter 3 that follows the parameter 2 is “then”, it indicates the “if-then” pattern, whereas the parameter 3 is “then-else”, it indicates the “if-then-else” pattern. In the case where the parameter 1 specifies the “if” structure and “pattern” is omitted, it indicates the “if-then” pattern.

“nest” specifies an arrangement of the control structures specified by the parameter 1 to be nested. The nesting depth is specified by the parameter 3 that follows the “nest”.

“parallel” specifies a parallel arrangement of the control structures specified by the parameter 1. The number of parallel structures is specified by the parameter 3 that follows the “parallel”.

“number” specifies the number of MLSL scripts (that is equal to the number of test programs) which should be generated. That number is specified by the parameter 3 that follows the “number”. If the parameter 3 indicates a character string “all”, not a numeric value, it means that all of the MLSL scripts that can be generated should be generated.

“depend” specifies, in a program, setting of a dependency between program statements. The number of points at which the dependency should be set is specified by the parameter 3 that follows “depend”.

“compare” specifies setting of an output statement for outputting a predetermined character string or the like. When the test program which has been finally generated by the present test program generation apparatus 1 is compiled by the compiler 10 and further executed by the target computer 11, a programmer can compare the output by the output statement with the point marked in the MLSL script so as to verify the operation.

The parameter 3 specifies a pattern of an “if” structure in the case where the parameter 2 is “pattern”, or a numerical range of the parameter 2. As shown in FIG. 7, “then” and “then-else” (or “else”) indicate the patterns of the if structure for the case where the parameter 2 is “pattern”. In the case where the parameter 2 is “pattern” and the parameter 3 is omitted, the pattern is “if-then”.

“L-M” (where L and M are integers) specifies a combination (or an arrangement) of control structures within a range of values L to M, in the case where “L-M” follows the parameter 1 “nest” or “parallel”. In the case where “L-M” follows “depend” or “compare”, it specifies setting of data dependencies or output statements within a range of values L to M.

“N” (where N is an integer) specifies placement of control structures at locations of up to the value N inclusive, in the case where it follows the parameter 1 “nest” or “parallel”. In the case where it follows “depend” or “compare”, it specifies setting of dependencies or output statements at N points. Note that, in this case, it may specify setting of dependencies or output statements in every N blocks or every (N+1) blocks.

“All” can be specified as a parameter 3 that follows the parameter 2 “number”, and means that all the MLSL scripts that can be generated should be generated.

For example, “nest: 1-2” means the nesting depth of the specified control structures is in a range of 1 (no nest) to 2 (one nest). “parallel: 1-2” means the number of the specified parallel control structures is in a range of 1 (no parallel) to 2. In the case where the parameter 3 is omitted, it is considered to be a default value which is previously set by a user. This default value is set for each type of the parameter 2.

As for the parameters 2 and 3, a plurality of them can be written in the brackets { } following the parameter 1, and each of them specifies one of the following: (1) a pattern of an “if” structure; (2) a combination or an arrangement of control structures specified by the parameter 1 in a program (“nest” or “parallel”); (3) the number of test programs to be generated (“number”); and (4) the number of information to be added to a test program (“depend” or “compare”). The above-mentioned (1) and (2) allow specification of a variety of arrangements of control structures in a single HLSL script, namely, specification of a plurality of program structures which are to be arranged in different ways. The above-mentioned (3) allows specification of the number of test programs to be generated, as a programmer desires. The above-mentioned (4) allows a programmer to verify the data dependency and the execution flow easily in the case where he/she causes a compiler to compile a test program into a machine language program and a target computer to execute the machine language program.

(MLSL Syntax)

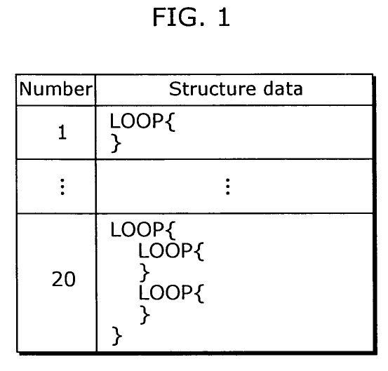

An MLSL script is, for example, the script 2b in FIG. 2, the script 3a in FIG. 3 or the like. Each of the structure data in FIG. 1 is also an MLSL script.

As shown in these examples, an MLSL script is written as a combination of a plurality of parameters indicating control structures, and indicates an arrangement of the control structures uniquely. The parameters in the MLSL script are LOOP, if (if-then or if-then-else) and the like.

(Detailed Configuration of Translation Unit 2)

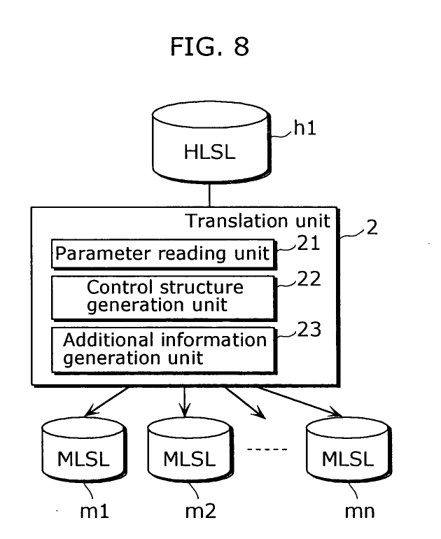

FIG. 8 is a functional block diagram showing a more detailed configuration of the translation unit 2. As shown in FIG. 8, the translation unit 2 includes a parameter reading unit 21, a control structure generation unit 22 and an additional information generation unit 23.

The parameter reading unit 21 reads the parameters 1 to 3 written in an HLSL script and outputs them to the control structure generation unit 22. However, it outputs, to the additional information generation unit 23, only the specification of information to be added to a test program (“depend” or “compare”) in the parameter 1.

As for the parameters 1 to 3 read by the parameter reading unit 21, the control structure generation unit 22 performs the processing for generating a plurality of MLSL scripts by arranging the control structures specified by the parameters 1 in accordance with the arrangements specified by the parameters 2. See, for example, the MLSL scripts m1, m2 and mn, as shown in FIG. 6.

The additional information generation unit 23 puts marks at the points at which the additional information should be set, in each of the plurality of MLSL scripts generated by the control structure generation unit 22, in accordance with the information to be added to the test programs which is specified in the parameters read by the parameter reading unit 21. There are two types of marks: a mark corresponding to “depend”; and a mark corresponding to “compare”. The plurality of MLSL scripts on which these marks are put are converted into a plurality of test programs respectively by the generation unit 3. At that time, the generation unit 3 sets program statements having data dependencies at the respective points in the test program that correspond to the “depend”-marked points in the MLSL script. The generation unit 3 also sets output statements at the respective points in the test program that correspond to the “compare”-marked points in the MLSL script.

A programmer can verify the execution flow using these program statements or the output statements.

(Parameter Reading Processing)

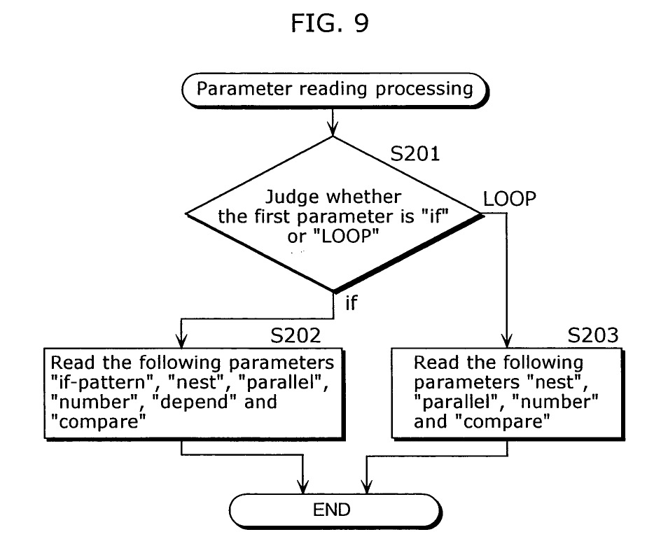

FIG. 9 is a flowchart showing the details of the parameter reading processing in the parameter reading unit 21 as shown in FIG. 8.

In FIG. 9, the parameter reading unit 21 judges whether the parameter 1 written in the HLSL script is “if” or “LOOP” (S201). When the parameter 1 is “if” as a result of the judgment, the parameter reading unit 21 reads the following parameters 2 and 3, and outputs the parameters 1, 2 and 3 concerning “pattern”, “nest”, “parallel” and “number” to the control structure generation unit 22, whereas outputs the parameters 2 and 3 concerning “depend” and “compare” to the additional information generation unit 23 (S202). When the parameter 1 is “LOOP” as a result of the judgment, the parameter reading unit 21 reads the following parameters 2 and 3, and outputs the parameters 1, 2 and 3 concerning “nest”, “parallel” and “number”, whereas outputs the parameters 2 and 3 concerning “depend” and “compare” to the additional information generation unit 23 (S203).

(Control Structure Generation Processing)

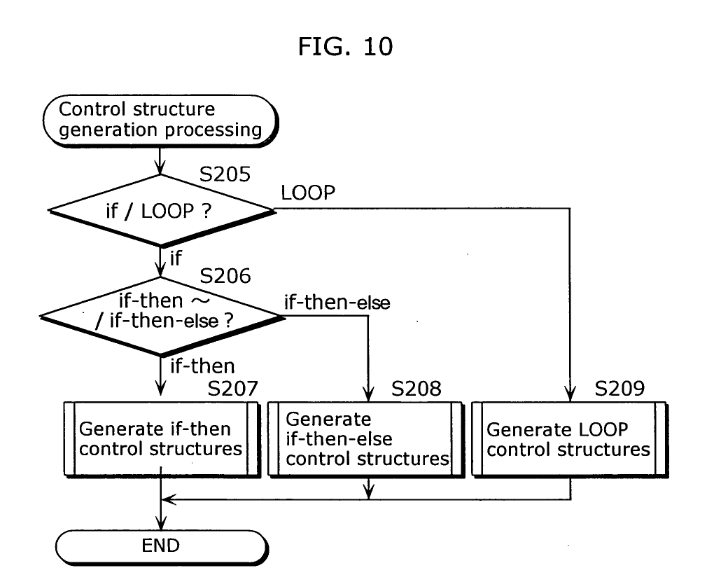

FIG. 10 is a flowchart showing the control structure generation processing in the control structure generation unit 22 as shown in FIG. 8.

The control structure generation unit 22 judges whether the parameter 1 outputted from the parameter reading unit 21 is “if” or “LOOP” (S205), and performs the loop control structure generation processing when the parameter 1 is “LOOP” as a result of the judgment. In this loop control structure generation processing, the control structure generation unit 22 generates a variety of arrangements of the loop control structures within a range of values specified by the parameter, and generates a plurality of MLSL scripts having the program structures that correspond to the respective arrangements (S209).

When the parameter 1 is “if” as a result of the judgment and “pattern” and “then” are specified by the parameter 2 and the parameter 3 respectively (or “pattern” is omitted, or “then” or “then-else” is omitted although “pattern” is specified), the control structure generation unit 22 performs the if control structure generation processing. In this if control structure generation processing, the control structure generation unit 22 generates a variety of arrangements of the if-then control structures within a range of values specified by the parameter, and generates a plurality of MLSL scripts having the program structures that correspond to the respective arrangements (S207).

When the parameter 1 is “if” as a result of the judgment and “pattern” and “then-else” are specified by the parameter 2 and the parameter 3 respectively, the control structure generation unit 22 performs the if-then-else control structure generation processing. In this if-then-else control structure generation processing, the control structure generation unit 22 generates a variety of arrangements of the if-then-else control structures within a range of values specified by the parameter, and generates a plurality of MLSL scripts having the program structures that correspond to the respective arrangements (S208).

(Details of If-then Control Structure Generation Processing)

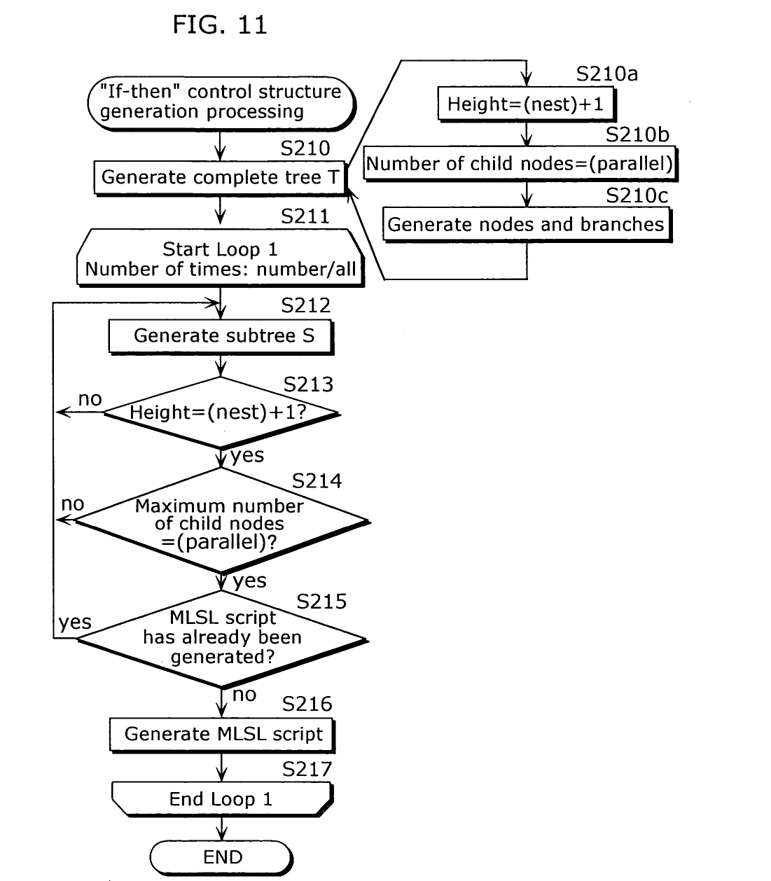

FIG. 11 is a flowchart showing the details of the if (if-then) control structure generation processing as shown in Step S207 in FIG. 10.

First, the control structure generation unit 22 generates a complete tree, in accordance with the value of the parameter 3 for “parallel” (the maximum value thereof will be hereinafter referred to as “the number of parallel control structures”) and the value of the parameter 3 for “nest” (the maximum value thereof will be hereinafter referred to as “the nesting depth”) which are outputted from the parameter reading unit 21 (S210). To be more specific, the control structure generation unit 22 determines the height of the tree (the node depth) to be the value of the nesting depth plus one (S210a), determines the number of child nodes (the number of branches) of each node to be the value of the number of parallel control structures (S210b), and then generates the data representing the complete tree in accordance with the determined height and number of branches (S210c).

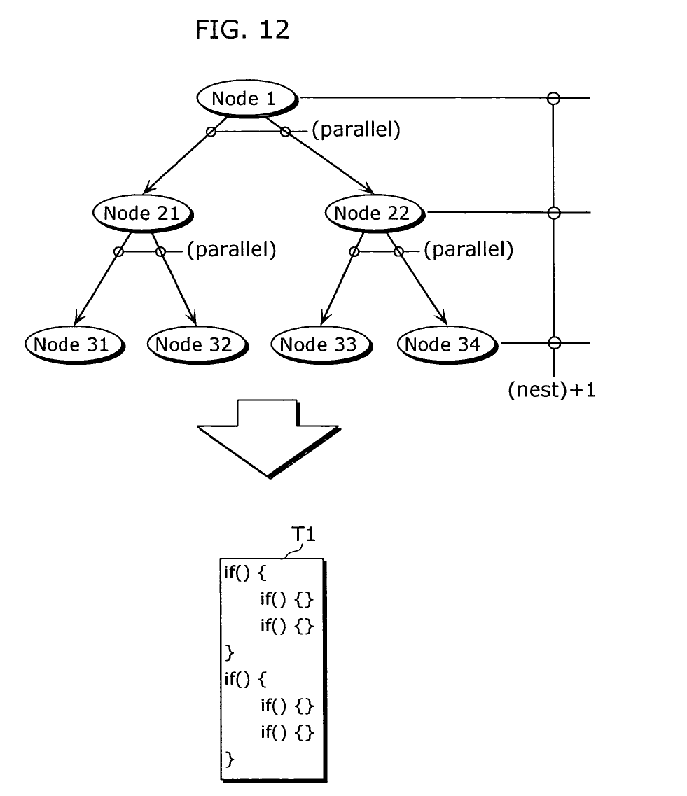

FIG. 12 is a diagram showing a complete tree T which is generated by the control structure generation unit 22 in the case where parallel: 2 and nest: 2, and the corresponding MLSL script. As shown in FIG. 12, the height of the tree is 3 (the nesting depth 2 plus 1) and the number of child nodes is 2 (the number of parallel control structures). When comparing this complete tree with the MLSL script T1, every node except for the root node (node 1) corresponds to every “if” statement. To be more specific, as shown in the MLSL script T1 in FIG. 12, the complete tree T represents a program structure in which as many control structures as possible specified by the parameters (“nest” and “parallel”) in the HLSL script are arranged.

Next, the control structure generation unit 22 generates a plurality of subtrees from the complete tree (Loop 1 in S212 to S217). The number of generated subtrees is the number specified by “number”. Each subtree represents a program structure in which one or more of the control structures defined in the HLSL script are arranged within the number of control structures included in the complete tree. Note that the subtrees which are generated here include the complete tree itself.

To be more specific, the control structure generation unit 22 generates one subtree S from the complete tree on a random basis (S212), and returns to the generation of a subtree unless the height of the subtree S is the nesting depth plus 1 (S213), and returns to the generation of a subtree unless the maximum number of child nodes is the number of parallel control structures (S214). The control structure generation unit 22 returns to the generation of a subtree because the generated subtree S does not have the control structures (nodes) of the number specified by the parameters (“nest” and “parallel”).

Furthermore, the control structure generation unit 22 judges whether the MLSL script corresponding to the generated subtree has already been generated or not (S215), and generates the MLSL script corresponding to the subtree if the script has not yet been generated (S216).

As a result of the above processing, one subtree is generated. The control structure generation unit 22 repeats the above processing (Loop 1) until the subtrees of the number specified by the parameter “number” are generated.

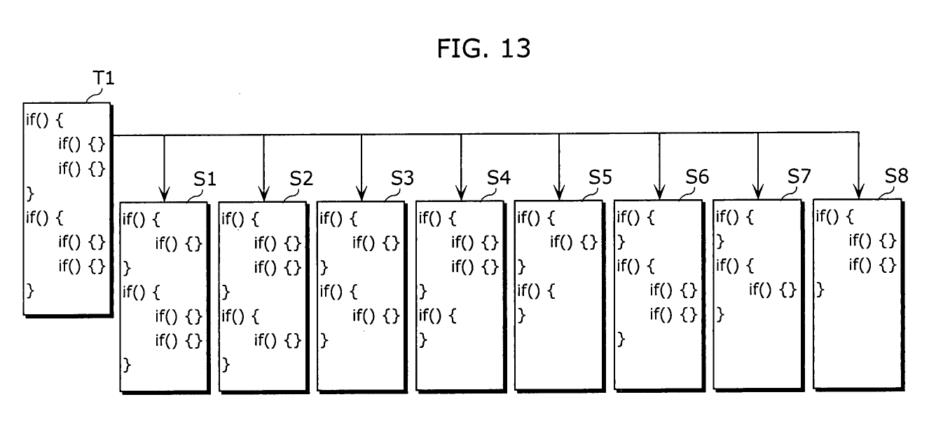

FIG. 13 is a diagram showing MLSL scripts that correspond to the subtrees generated from the complete tree as shown in FIG. 12. FIG. 13 shows nine MLSL scripts that correspond to one complete tree T1 and all the subtrees which are generated in the case where “all” is specified as “number”. In FIG. 13, MLSL script T1 corresponds to the complete tree. MLSL scripts S1 to S8 respectively correspond to subtrees in which one or more nodes included in the complete tree are deleted.

(Details of If-then-else Control Structure Generation Processing)

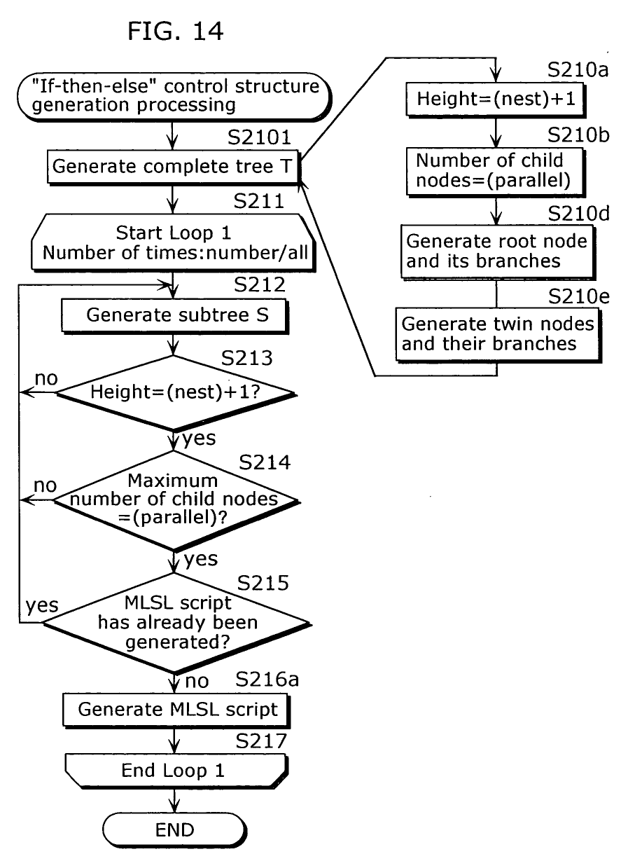

FIG. 14 is a flowchart showing “if-then-else” control structure generation processing as shown in Step S208 in FIG. 10.

The flow of FIG. 14 is different from the flow of FIG. 11 in that the former has Step S2101 instead of Step S210 (namely, Steps S210d and S210e instead of Step S210c) and has Step S216a instead of Step S216. The following explanation will be focused on the different steps, and the explanation of the same steps will not be repeated here.

In Step S210a, the control structure generation unit 22 generates a complete tree having nodes corresponding to “if” statements of if-then-else pattern. For that purpose, after determining the height of the tree and the number of child nodes, the control structure generation unit 22 generates the root node and its branches (5210d), and further generates twin nodes and their branches in accordance with the determined height and number of child nodes, considering that all the child nodes under the root node are twin nodes (S210e).

Step S216a is different from Step S216 in that the control structure generation unit 22 generates MLSL scripts in which the control structures of if-then-else pattern, not if-then pattern, are arranged.

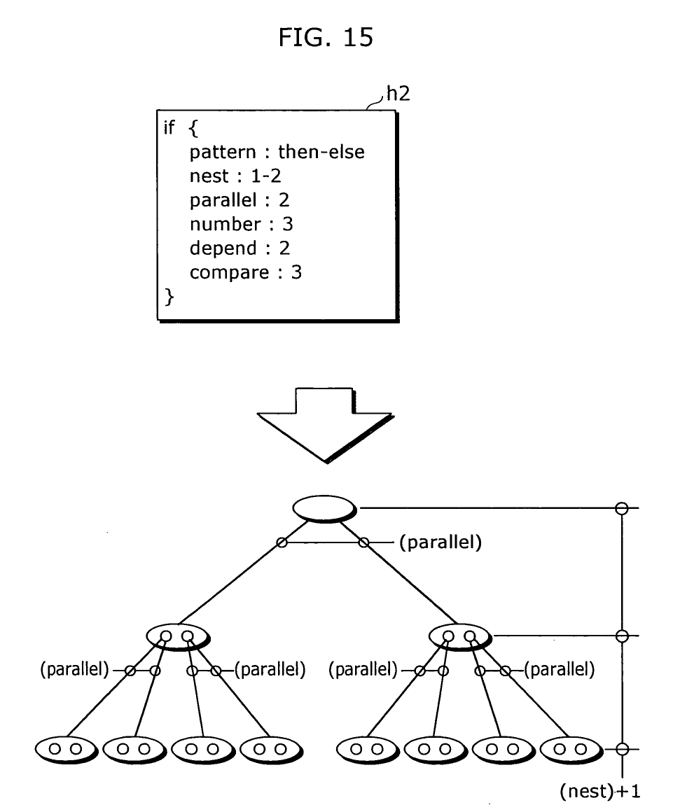

FIG. 15 shows an example of an HLSL script that defines control structures of if-then-else pattern and the corresponding complete tree. In FIG. 15, an HLSL script h2 defines that the nesting depth is 2 and the number of parallel control structures is 2. In the complete tree that corresponds to the HLSL script h2, all the nodes except for the root node are twin nodes containing two nodes respectively. The left node in the twin node corresponds to “then” of if-then-else pattern, whereas the right node corresponds to “else” thereof.

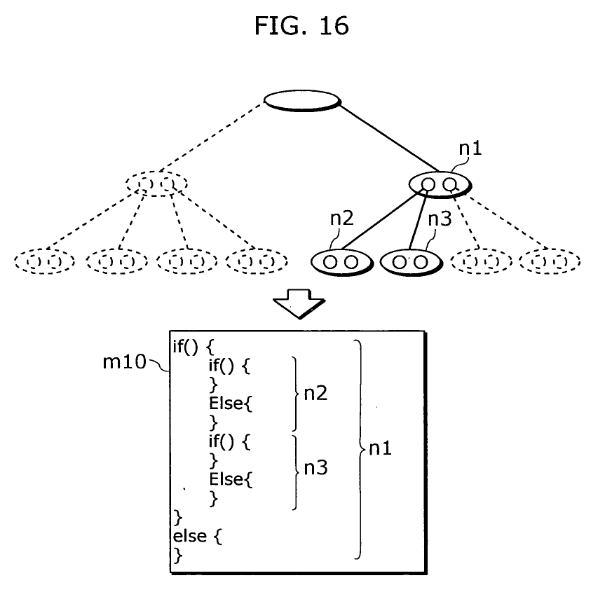

FIG. 16 shows the first example of a subtree generated by the control structure generation unit 22 and the corresponding MLSL script generated from the subtree. In FIG. 16, two twin nodes n2 and n3 are connected to the left node in the twin node n1. In the corresponding MLSL script, two if-then-else statements that correspond to the two parallel twin nodes n2 and n3 are nested on the “then” side in the if-then-else statement that corresponds to the twin node n1.

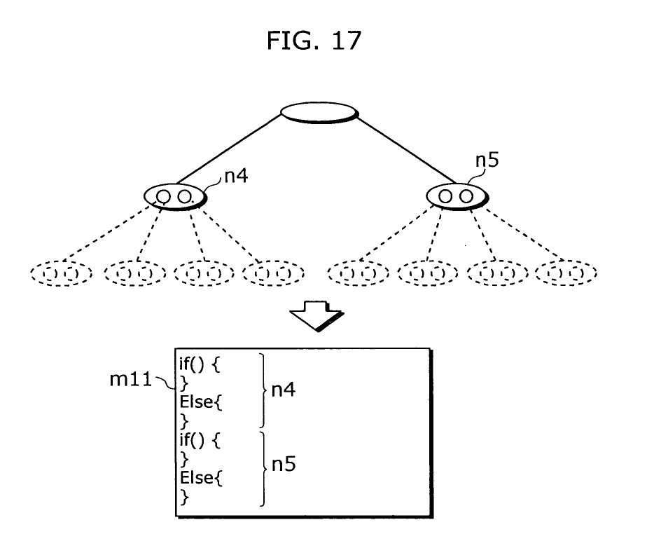

FIG. 17 shows the second example of a subtree generated by the control structure generation unit 22 and the corresponding MLSL script generated from the subtree. In FIG. 17, two twin nodes n4 and n5 under the root node correspond to two parallel if-then-else statements.

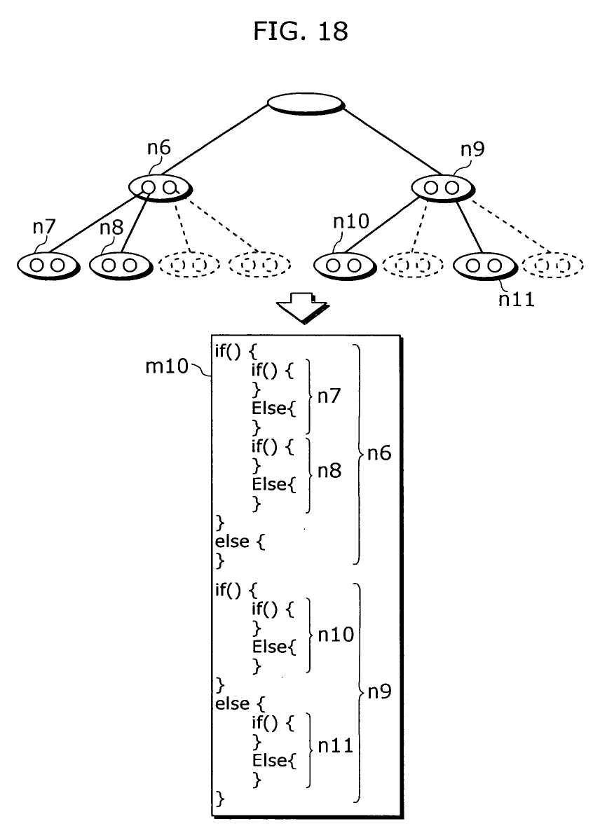

FIG. 18 shows the third example of a subtree generated by the control structure generation unit 22 and the corresponding MLSL script generated from the subtree. In FIG. 18, the subtree has six twin nodes. In the corresponding MLSL script, two if-then-else statements that correspond to the twin nodes n6 and n9 are parallel. Two if-then-else statements that correspond to the two parallel twin nodes n7 and n8 are nested on the “then” side in the if-then-else statement that corresponds to the twin node n6. The if-then-else statement that corresponds to the twin node n10 is nested on the “then” side in the if-then-else statement that corresponds to the twin node n9, and the if-then-else statement that corresponds to the twin node n11 is nested on the “else” side therein.

The control structure generation unit 22 generates the MLSL scripts that correspond to the subtrees as shown in FIG. 16 to FIG. 18 in the above-mentioned manner.

(Details of Loop Control Structure Generation Processing)

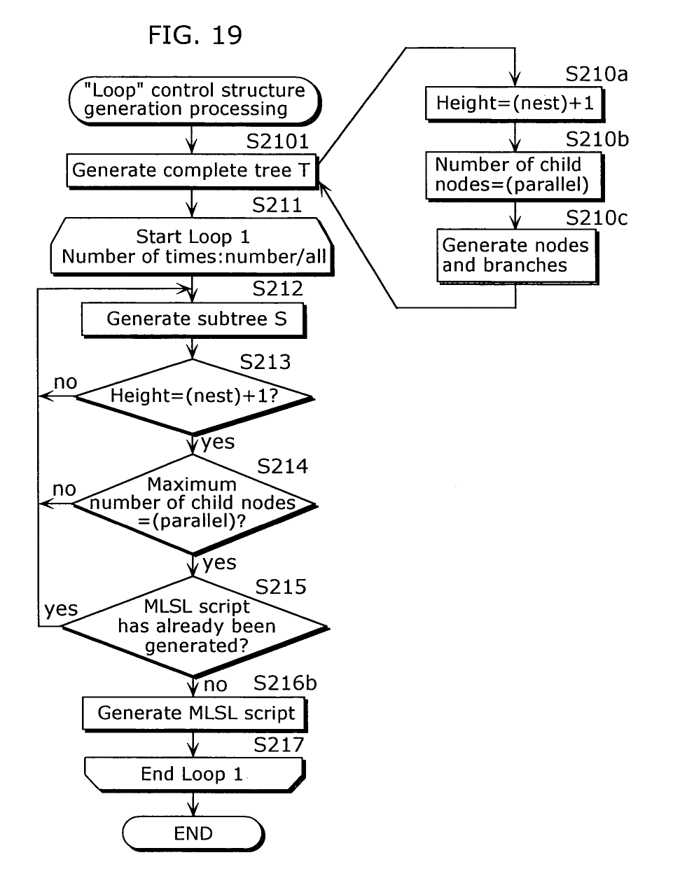

FIG. 19 is a flowchart showing loop control structure generation processing as shown in Step S209 in FIG. 10. The flow of FIG. 19 is different from the flow of FIG. 11 in that the former includes Step 216b instead of Step S216 in the latter. The following explanation will be focused on the different step, and the explanation of the same steps will not be repeated here.

In Step S216b, the control structure generation unit 22 generates loop control structures, instead of if-then control structures in Step S216. To be more specific, the control structure generation unit 22 generates a plurality of MLSL scripts representing “LOOP{ }”, instead of “if( ){ }” in the MLSL scripts in FIG. 12 and FIG. 13.

Note that the control structure generation processing for the control structures of if-then pattern, if-then-else pattern and loop pattern has been described separately, but these patterns may be mixed. For example, in the case where a mixture of if-then control structures and if-then-else control structures are defined, the control structure generation unit 22 once generates a complete tree by considering the if-then structures as the if-then-else structures and then adds the processing of replacing some of the twin nodes with ordinary nodes within a range of values specified by the parameters “parallel” and “nest”. The same processing can also be performed in the case where loop control structures and if-then-else control structures or if-then control structures are mixed.

(Additional Information Generation Processing)

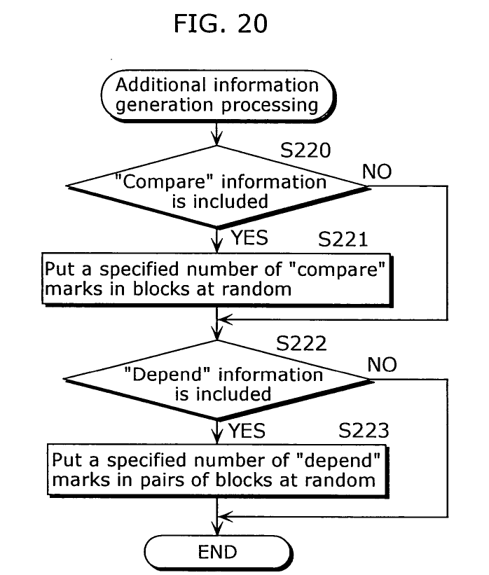

FIG. 20 is a flowchart showing additional information generation processing in the additional information generation unit 23 as shown in FIG. 8.

In the case where the parameters outputted from the parameter reading unit 21 include “compare” and the following parameter 3 (S220), the additional information generation unit 23 puts the marks of the number specified by the parameter 3 (hereinafter referred to compare marks) in each of a plurality of MLSL scripts generated by the control structure generation unit 22 (S221). Here, a compare mark is a mark that specifies the point at which an output statement for indicating the program execution point and status should be set. To be more specific, the compare marks are put in every specified number of blocks. Here, a block (also called a basic block) denotes a sequence of instructions, as a unit in a program, which is always executed in succession without being branched in the middle of the sequence. In other words, in a single block, no branch occurs from any instructions except for the last one in the program. In an MLSL script, a block corresponds to each region of a program separated by an “if” or “loop” control structure. The blocks in which the compare marks are put are selected from all the blocks at random.

In addition, in the case where the parameters outputted from the parameter reading unit 21 include “depend” and the following parameter 3 (S222), the additional information generation unit 23 puts the marks of the number specified by the parameter 3 (hereinafter referred to as depend marks) to each of a plurality of MLSL scripts generated by the control structure generation unit 22 (S223). Here, one depend mark is a pair of marks that specifies the points at which two program statements which have data dependency should be set.

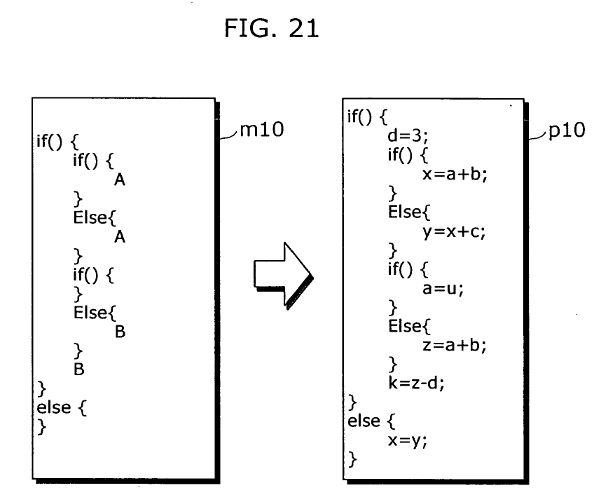

FIG. 21 is a diagram showing an example of an MLSL script in which depend marks are put by the additional information generation unit 23 and the resulting test program. In FIG. 21, pairs of marks “A”s and “B”s in the MLSL script m10 are the depend marks.

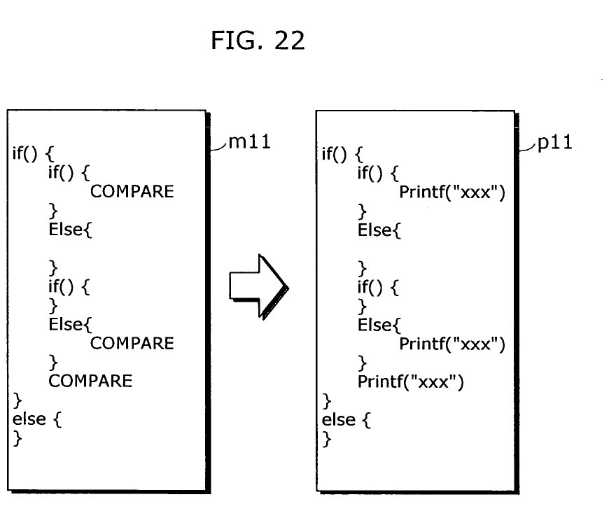

FIG. 22 is a diagram showing an example of an MLSL script in which compare marks are put by the additional information generation unit 23 and the resulting test program. In FIG. 22, three “COMPARE”s in the MLSL script m11 are the compare marks.

(Detailed Structure of Generation Unit)

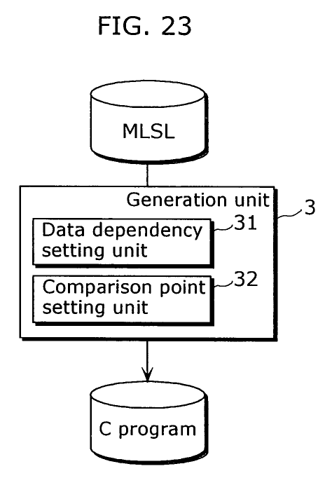

FIG. 23 is a block diagram showing the more detailed configuration of the generation unit 3. As shown in FIG. 23, the generation unit 3 includes a data dependency setting unit 31 and a comparison point setting unit 32, and generates test programs to be compiled by the compiler 10. In the present embodiment, the test programs are C language source programs.

The generation unit 3 generates a source program having control structures that correspond to “LOOP”s and “if”s written as control structures in an MLSL script. For example, it generates a “for” statement for iteration processing in accordance with “LOOP” in an MLSL script, generates an “if” statement in accordance with “if” in an MLSL script, and generates an “if( ){ }else{ }” statement in accordance with an if-then-else in an MLSL script, respectively. This kind of generation of a test program from an MLSL script may be done using the same technique as the conventional art for converting the script in FIG. 2 into the source program in FIG. 3. However, the conventional art cannot handle depend marks and compare marks.

The data dependency setting unit 31 puts program statements having data dependency at the depend-marked point, for generating a test program.

The comparison point setting unit 32 puts an output statement at the compare-marked point, for generating a test program.

(Data Dependency Setting Processing Flow)

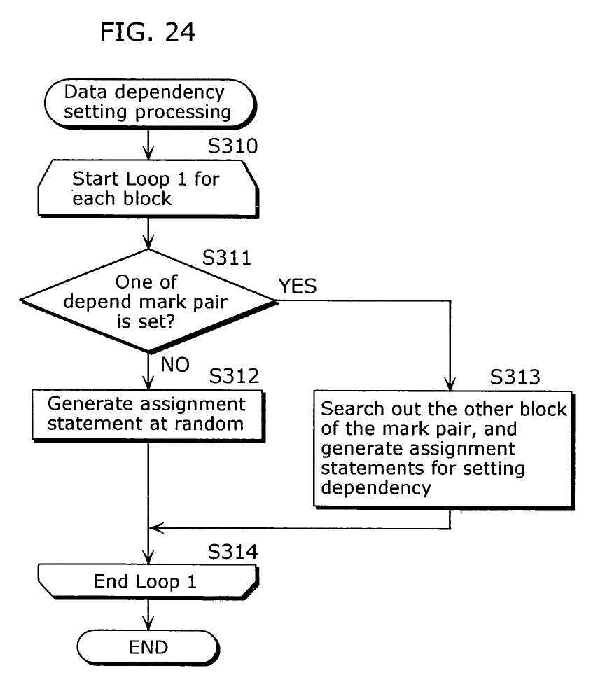

FIG. 24 is a flowchart showing data dependency setting processing in the data dependency setting unit 31 as shown in FIG. 23.

As shown in FIG. 24, the data dependency setting unit 31 performs the processing of Steps S310 to S314 for each block in an MLSL script.

The data dependency setting unit 31 judges whether or not a data dependency mark (one of a pair of depend marks) is set in a current block in an MLSL script (S311). When judging that the mark is not set, the data dependency setting unit 31 generates, at random, an assignment statement as a program statement for describing the current block in the test program (S312). When judging that the mark is set, the data dependency setting unit 31 searches the MLSL script for a block in which the other of the pair of depend marks is put, and generates two assignment statements having data dependency for the pair of blocks in the test program (S313). In the case where the assignment statement having data dependency has already been set, the processing in Step S313 may be omitted.

The test program p10 as shown in FIG. 21 is an example of program statements having data dependency set by the data dependency setting unit 31. As shown in FIG. 21, two program statements (assignment statements) having data dependency, x=a+b; and y=x+c; are set at the points A (a pair of A marks) in the MLSL script m10. In this case, these two program statements have data dependency through a variable x. In addition, two program statements having data dependency, z=a+b; and k=z−d; are set at the points B (a pair of B marks). In this case, these two program statements have data dependency through a variable z.

Note that the data dependency setting unit 31 may assign a pair of marks to a basic block corresponding to “then” and a basic block corresponding to “else”, like a pair of A marks. Furthermore, the data dependency setting unit 31 may assign a pair of marks to the following: (a) adjacent two basic blocks; (b) a basic block corresponding to “if” and a basic block corresponding to “then”; and (c) a basic block corresponding to “if” and a basic block corresponding to “else”.

(Comparison Point Setting Processing Flow)

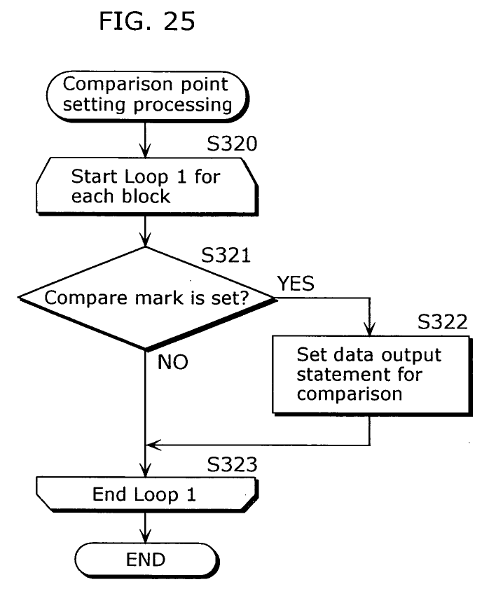

FIG. 25 is a flowchart showing comparison point setting processing in the comparison point setting unit 32 as shown in FIG. 23.

As shown in FIG. 25, the processing of Steps S320 to S323 (Loop 1) is performed for each block in an MLSL script. The data dependency setting unit 31 judges whether or not a comparison point mark (compare mark) is set in a current block in the MLSL script (S321). When judging that the mark is set, the comparison point setting unit 32 sets an output statement in the block of the test program that corresponds to the marked point (S322).

The test program p11 in FIG. 22 is an example of an output statement set by the comparison point setting unit 32. As shown in FIG. 22, output statements “Printf(“xxx”);” and the like are set in the blocks of the test program p10 that correspond to the points marked as COMPARE in the MLSL script m11. In this case, a programmer can previously set the output statements to be generated on the test program generation apparatus 1. The contents to be outputted “xxx” may be character strings indicating the points of the output, a part or all of variable values, or results of specific operation.

The present invention is not limited to the above-mentioned embodiment, and various changes or modifications are possible without departing from the scope of the present invention.

In the above embodiment, generation of a C language source program as a test program has been explained as an example, but a test program written in any of other high level languages than C language may be generated. In that case, LOOP and if as the parameters 1 have to be corresponded to the control structures which can be written in that high-level language (such as if structures, for structures, and while structures).

In addition, the above embodiment has been explained, as an example, on the assumption that one control structure is specified by one parameter 1 in one HLSL script, but a plurality of parameters 1 may be specified in a single HLSL script, or various control structures may be specified by a plurality of parameters 1. For example, a parameter 1 specifying an if-then structure and a parameter 1 specifying an if-then-else structure may be mixed, or a parameter 1 specifying a loop structure and a parameter 1 specifying an if-then-else structure may be mixed.

Furthermore, in the above embodiment, a test program for a compiler is generated. However, a test program for an interpreter or an assembler, instead of a compiler, may be generated, or a test program may be targeted for a virtual machine for interpreting and executing a script language such as JAVA® and VisualBasic®.

In the above embodiment, LOOP and if have been explained as parameters 1 specifying control structures, but the parameters specifying other control structures may be included. For example, parameters indicating sequence structures, recursive structures, n-branch structures indicating a 1-to-n branch and the like may be included.

Note that in the above embodiment, the program generated by the test program generation apparatus 1 is a test program used for verifying operation of a compiler under development. However, it goes without saying that the program can be used for verifying operation of the target machine 11 under development.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A program generation apparatus comprising:
an accepting unit operable to accept a first script that defines a plurality of program structures for programs to be generated; and
a script generating unit operable to generate a plurality of second scripts, each of which describes one of the plurality of program structures defined by the first script, said one of the plurality of program structures being different from each other.

2. The program generation apparatus according to claim 1,
wherein the first script defines the plurality of program structures by indicating a plurality of arrangements of control structures in the programs to be generated,
each of the second scripts describes a program structure that indicates a unique arrangement of one or more of the control structures, and
the script generating unit generates the plurality of second scripts by arranging the control structures based on the plurality of arrangements indicated in the first scrip.

3. The program generation apparatus according to claim 2,
wherein the control structures include a loop structure.

4. The program generation apparatus according to claim 2,
wherein the control structures include a branch structure.

5. The program generation apparatus according to claim 4,
wherein the branch structure includes an if-then branch structure.

6. The program generation apparatus according to claim 4,
wherein the branch structure includes an if-then-else branch structure.

7. The program generation apparatus according to claim 2,
wherein the first script includes an indication of paralleling of the control structures.

8. The program generation apparatus according to claim 2,
wherein the first script includes an indication of nesting of the control structures.

9. The program generation apparatus according to claim 2,
wherein the first script includes an indication of paralleling and nesting of the control structures.

10. The program generation apparatus according to claim 2,
wherein the first script includes an indication of the number of programs to be generated, and
the script generating unit generates the plurality of second scripts, the number of said generated second scripts being indicated in the first script, and said second scripts describing the program structures selected, on a random basis, from among the plurality of program structures defined by the first script.

11. The program generation apparatus according to claim 2,
wherein the script generating unit generates the plurality of second scripts that correspond to all of the plurality of program structures defined by the first script.

12. The program generation apparatus according to claim 1,
wherein the first script further includes a parameter indicating that a specific program statement should be set at a plurality of points in each of the programs, and
the script generating unit puts a mark that represents the parameter at a plurality of points in each of the second scripts.

13. The program generation apparatus according to claim 12,
wherein the specific program statement is an output statement indicating that one of a character string and a variable should be outputted.

14. The program generation apparatus according to claim 12,
wherein the specific program statement is a pair of assignment statements that have data dependency.

15. The program generation apparatus according to claim 1,
wherein the first script includes a first parameter and a second parameter, the first parameter indicating a type of control structures to be set in the programs to be generated, and the second parameter indicating a plurality of arrangements of the control structures,
each of the second scripts describes a program structure that indicates a unique arrangement of one or more of the control structures, and
the script generating unit includes:
a reading unit operable to read the first parameter and the second parameter from the first script; and
a control structure generating unit operable to generate the plurality of second scripts based on the type of control structures indicated by the first parameter and the plurality of arrangements of the control structures indicated by the second parameter.

16. The program generation apparatus according to claim 15,
wherein the first parameter indicates at least one of a loop structure and a branch structure as the type of control structures, and
the second parameter indicates at least one of the following: a range of numbers of said control structures which should be set in parallel; and a range of nesting depths of said control structures which should be set as nests.

17. The program generation apparatus according to claim 16,
wherein the control structure generating unit includes:
a complete tree generating unit operable to generate complete tree data indicating a complete tree that corresponds to a complete arrangement that has a maximum number of control structures to be arranged within the range indicated by the second parameter;
a subtree generating unit operable to generate a plurality of subtree data indicating subtrees of the generated complete tree; and
a second script generating unit operable to generate the second scripts, each of which describes a program structure that indicates a unique arrangement of one or more of the control structures corresponding to each of the generated subtrees.

18. The program generation apparatus according to claim 17,
wherein the complete tree generating unit (i) determines a height of the complete tree that is a maximum node depth in said complete tree, said height being a value which is obtained by adding one to a maximum value of a nesting depth within the range indicated by the second parameter, (ii) determines a number of child nodes of each node in the complete tree, said number of child nodes being a maximum number of parallel control structures within the range indicated by the second parameter, and (iii) generates tree structure data, as the complete tree, in accordance with the determined height and number of child nodes,
wherein in a case where the first parameter indicates an if-then-else branch structure, in the generation of the complete tree in (iii), the complete tree generating unit generates all of the nodes except for a root node as twin nodes, and then generates the complete tree so that each node in each of the twin nodes branches to twin nodes of the determined number of child nodes.

19. The program generation apparatus according to claim 15,
wherein the first script includes an indication that a data dependency should be set, and an indication of a number concerning the data dependency to be set, and
the script generating unit further includes a marking unit operable to put the indicated number of dependency marks in each of the second scripts generated by the control structure generating unit, in accordance with the indication that the data dependency should be set, said dependency marks indicating points at which the data dependency should be set.

20. The program generation apparatus according to claim 19,
wherein the marking unit puts a pair of dependency marks in two neighboring basic blocks respectively.

21. The program generation apparatus according to claim 19,
wherein the control structures include an if-then-else branch structure, and
the marking unit puts the pair of dependency marks in a basic block that corresponds to “then” and a basic block that corresponds to “else”, respectively.

22. The program generation unit according to claim 15,
wherein the first script includes an indication that an output statement should be set, and an indication of a number concerning the output statement to be set, and
the script generating unit further includes a marking unit operable to put output marks, on a random basis, in the indicated number of basic blocks in each of the second scripts generated by the control structure generating unit, in accordance with the indication that the output statement should be set, said output marks indicating points at which the output statement should be set.

23. The program generation apparatus according to claim 15,
wherein the first script includes an indication that an output statement should be set, and an indication of a number concerning the output statement to be set, and
the script generation unit further includes a marking unit operable to put output marks in every indicated number of basic blocks in each of the second scripts generated by the control structure generating unit, in accordance with the indication that the output statement should be set, said output marks indicating points at which the output statement should be set.

24. The program generation apparatus according to claim 1, further comprising a program generating unit operable to generate a program that corresponds to each of the plurality of second scripts generated by the script generation unit.

25. A program generation method comprising:
an accepting step of accepting a first script that defines a plurality of program structures for programs to be generated; and
a script generating step of generating a plurality of second scripts, each of which describes one of the plurality of program structures defined by the first script, said one of the plurality of program structures being different from each other.

26. A program for program generation that causes a computer to execute:
an accepting step of accepting a first script that defines a plurality of program structures for programs to be generated; and
a script generating step of generating a plurality of second scripts, each of which describes one of the plurality of program structures defined by the first script, said one of the plurality of program structures being different from each other.

27. A script having a data structure which is processed by a program generation apparatus for generating a plurality of programs, the script comprising a high level script and a plurality of middle level scripts,
wherein the high level script is converted into the plurality of middle level scripts,
the plurality of middle level scripts are converted into the plurality of programs to be generated,
the high level script includes the following: a first parameter indicating a type of control structures to be set in the programs to be generated; a second parameter indicating a plurality of arrangements of the control structures; and a third parameter specifying a numerical range of the second parameter, and defines a plurality of program structures by indicating the plurality of arrangements of the control structures in the programs to be generated, and
each of the middle level scripts is written as a set of a plurality of fourth parameters indicating the control structures, and indicates one of the plurality of arrangements of the control structures.

28. The script according to claim 27,
wherein the high level script has a plurality of sets of the second parameter and the third parameter, which correspond to said one first parameter.

29. The script according to claim 27,
wherein the second parameter further specifies one of a program statement that indicates a data dependency and a program statement that indicates an output.
